(19) United States
(12) Patent Application Publication
(10) Pub. No.: US 2010/0169084 A1
(43) Pub. Date: Jul. 1, 2010

(54) METHOD AND APPARATUS FOR PITCH SEARCH

(75) Inventors: Dejun Zhang, Shenzhen (CN); Jianfeng Xu, Shenzhen (CN); Lei Miao, Shenzhen (CN); Fengyan Qi, Shenzhen (CN); Qing Zhang, Shenzhen (CN); Herve Marcel Taddei, Munich (DE); Lixiong Li, Shenzhen (CN); Fuwei Ma, Shenzhen (CN); Yang Gao, Irvine, CA (US)

Correspondence Address: FutureWei Technologies, Inc.;IPR & Standards Department, 1700 Alma Drive, Suite 500, Plano, TX, 75075, US

(73) Assignee: HUAWEI TECHNOLOGIES CO., LTD., Shenzhen (CN)

(21) Appl. No.: 12/646,669

(22) Filed: Dec. 23, 2009

(30) Foreign Application Priority Data
Dec. 30, 2008 (CN) 200810247031.1

(51) Int. Cl. G10L 11/04

(52) U.S. Cl. 704/207; 704/E11.006

(57) ABSTRACT

The present invention relates to a method and apparatus for pitch search. One method includes: obtaining a characteristic function value of a residual signal, where the residual signal is a result of removing a Long-Term Prediction (LTP) contribution signal from input speech signals; and obtaining a pitch according to the characteristic function value of the residual signal.

### CROSS-REFERENCE TO RELATED APPLICATIONS

This application claims priority to Chinese Patent Application No. 200810247031.1, filed on Dec. 30, 2008, which is hereby incorporated by reference in its entirety.

### FIELD OF THE INVENTION

The present invention relates to the field of speech coding and decoding technologies, and in particular, to a method and apparatus for pitch search.

### BACKGROUND OF THE INVENTION

Generally, speech and audio signals are somewhat periodic. The long-term periodicity in the speech and audio signals may be removed through a Long Term Prediction (LTP) method. Before LTP prediction, a pitch needs to be searched out first. A conventional method for pitch search is performed based on an autocorrelation function. In a Moving Pictures Experts Group Audio Lossless Coding (MPEG ALS) apparatus, the history data in the buffer is used as excitation signals to predict the signals of the current frame. Taking the open loop pitch analysis as an example, the method is described below.

First, the original speech signal is input into a perceptual weighting filter to obtain a weighted speech signal s_{w}(n). The expression of perceptual weighting filter function is

$$W ( z ) = A ( z / {γ}_{1} ) {H}_{d e \text{-} emph} ( z ) , where$$

$${H}_{de \text{-} emph} = \frac{1}{1 - {β}_{1} {z}^{- 1}} ,$$

and β1=0.68. For each subframe, the subframe length (L) is 64, and the expression of the weighted speech signal s_{w}(n) is:

$${s}_{w} ( n ) = s ( n ) + {\sum }_{i = 1}^{16} {a}_{i} {γ}_{1}^{i} s ( n - i ) + {β}_{1} {s}_{w} ( n - 1 ) , n = 0 , … , L - 1. \qquad ( 1 )$$

where s(n) is the original speech signal; αᵢ is an LP coefficient; and γ₁ⁱ is a perceptual weighting factor.

A four-order Finite Impulse Response (FIR) filter H_{decim2}(z) performs down-sampling by 2 on the weighted speech signal to obtain s_{wd}(n); the weighted correlation function is:

$$C ( d ) = {\sum }_{n = 0}^{63} {s}_{wd} ( n ) {s}_{wd} ( n - d ) w ( d ) , d = 17 , … , 115 \qquad ( 2 )$$

The obtained pitch is the pitch delay d that maximizes C(d), where w(d) is a weighting function that includes a low-delay weighting function wₗ(d) and a previous-frame delay weighting function wₙ(d), as shown in formula (3):

w(d)=wₗ(d)wₙ(d) (3)

The expression of the low-delay weighting function wₗ(d) is:

wₗ(d)=cw(d) (4)

where cw(d) exists in the tab file of the program, and the previous-frame delay weighting function wₙ(d) depends on the pitch delay of the previous frame, and the expression of the previous-frame delay weighting function wₙ(d) is:

$${w}_{n} ( d ) = \{ \begin{matrix}cw ( \vert {T}_{old} - d \vert + 98 ) , & v > 0.8 , \\ 1.0 , & other\end{matrix} \qquad ( 5 )$$

where, T_{old} is the average of the pitch delay in the first 5 frames, and v is an adaptive factor. When the open loop pitch gain (g) is greater than 0.6, the frame is regarded as a voiced frame, and “v” for the next frame is set to 1; otherwise, v=0.9v. The expression of the open loop pitch gain (g) is:

$$g = \frac{{\sum }_{n = 0}^{63} {s}_{wd} ( n ) {s}_{wd} ( n - {d}_{m ax} )}{\sqrt{{\sum }_{n = 0}^{63} {s}_{wd}^{2} ( n ) {\sum }_{n = 0}^{63} {s}_{wd}^{2} ( n - {d}_{m ax} )}} \qquad ( 6 )$$

The pitch delay is the one that maximizes C(d). The mid value filter is updated in the voiced frames. If the previous frame includes an unvoiced or silent sound, the weighting function is attenuated by parameter “v”.

As described above, in the prior art, to solve the long-term periodicity, an autocorrelation function is calculated for the input speech signals in a frame to obtain the pitch.

### SUMMARY OF THE INVENTION

Some embodiments of the present invention provide a method and apparatus for pitch search without calculating the correlation function values of the input speech signals in an entire frame.

A method for pitch search includes:

obtaining a characteristic function value of a residual signal, where the residual signal is a result of removing an LTP contribution signal from input speech signals; and

obtaining a pitch according to the characteristic function value of the residual signal.

Another method for pitch search includes:

searching input speech signals for a pulse with a maximum amplitude;

setting a target window for the input speech signals according to the position of the pulse with the maximum amplitude;

sliding the target window to obtain a sliding window, and calculating the correlation coefficient of the input speech signals in the sliding window and in the target window to obtain the maximum value of the correlation coefficient; and

obtaining a pitch according to the maximum value of the correlation coefficient.

An apparatus for pitch search includes:

a characteristic value obtaining module, adapted to obtain a characteristic function value of a residual signal, where the residual signal is a result of removing an LTP contribution signal from input speech signals; and

a pitch obtaining module, adapted to obtain a pitch according to the characteristic function value of the residual signal.

Another apparatus for pitch search includes:

a searching module, adapted to search input speech signals for a pulse with a maximum amplitude;

a target window module, adapted to set a target window for the input speech signals according to the position of the pulse with the maximum amplitude;

a calculating module, adapted to: slide the target window to obtain a sliding window, and calculate the correlation coefficient of the input speech signals in the sliding window and in the target window to obtain the maximum value of the correlation coefficient; and

a pitch obtaining module, adapted to obtain a pitch according to the maximum value of the correlation coefficient.

With the method and apparatus for pitch search in the embodiments of the present invention, the characteristic function value of the residual signal is obtained, and the pitch is obtained according to the characteristic function value of the residual signal, without the need of calculating the correlation function values of the input speech signals in the entire frame.

### BRIEF DESCRIPTION OF THE DRAWINGS

FIG. 1 is a flowchart of a method for pitch search according to one embodiment of the present invention;

FIG. 2 is a flowchart of a method for pitch search according to another embodiment of the present invention;

FIG. 3 is a flowchart of a method for pitch search according to yet another embodiment of the present invention;

FIG. 4 is a flowchart of method for pitch search according to yet another embodiment of the present invention;

FIG. 5 is a flowchart of method for pitch search according to yet another embodiment of the present invention;

FIG. 6 shows a schematic structural view of an apparatus for pitch search according to one embodiment of the present invention; and

FIG. 7 shows a schematic structural view of apparatus for searching a pitch according to another embodiment of the present invention.

### DETAILED DESCRIPTION OF THE EMBODIMENTS

The present invention is hereinafter described in detail with reference to accompanying drawings and exemplary embodiments.

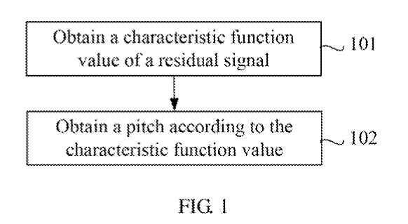

FIG. 1 is a flowchart of a method for pitch search according to one embodiment of the present invention. The method includes the following steps:

Step 101: Obtain a characteristic function value of a residual signal, where the residual signal is a result of removing an LTP contribution signal from input speech signals.

Step 102: Obtain a pitch according to the characteristic function value of the residual signal.

In the method according to this embodiment, obtain the characteristic function value of the residual signal, and the pitch is obtained according to the characteristic function value of the residual signal, without calculating the correlation function values of the input speech signals in the entire frame.

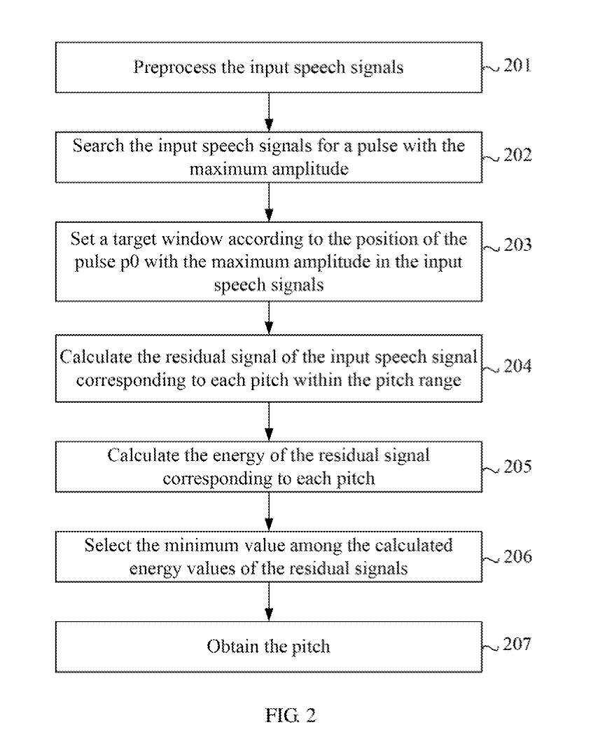

FIG. 2 is a flowchart of a method for pitch search according to another embodiment of the present invention. The method includes the following steps:

Step 201: Preprocess the input speech signals.

The preprocessing may be low-pass filtering or down-sampling, or may be a low-pass filtering process followed by a down-sampling process. In one embodiment, the low-pass filtering may be mean-value filtering. Taking a Pulse Coded Modulation (PCM) signal as an example, y(n) represents an input speech signal, and the frame length L of the input speech signal is 160 (that is, one frame includes 160 samples); y2(n) represents the down-sampled, and is hereinafter referred to as a down-sampled signal. Taking the down-sampling by 2 as an example in this embodiment, the following equation applies:

$$y 2 ( n ) = \frac{1}{M} {\sum }_{i = 1}^{M} y ( 2 n - i ) , n = 0 , 1 , … , ( L / 2 - 1 ) . \qquad ( 7 )$$

where, M is the order of the mean filter, and the sample range of y2(n) is [0, 79].

This step is optional. The preprocessing may be omitted before step 202 occurs.

Step 202: Search the input speech signals for a pulse with the maximum amplitude.

The pulse may be searched within the entire frame, or within a set range of a frame. Taking searching for the pulse in a set range of a frame as an example, the process is detailed below:

First, for the input speech signal y(n), its pitch range is pre-set according to the frame length. The pitch range is set with reference to the frame length, and the pitch should not be too high. If the pitch is too high, few samples in the signals of a frame are involved in the LTP calculation, and the LTP performance is degraded. For example, if the frame length L equals to 160, the pitch range of y(n) may be set to [20, 83]. According to one embodiment, down-sampling by 2 is applied in step 202. The pitch range of the down-sampled signal y2(n) may be [10, 41], namely, [PMIN, PMAX], where PMIN=10, and PMAX=41. To ensure that the pitch can be found when the pitch is the maximum, the sample range of the pulse being searched may be set to [41, 79].

Afterward, within the sample range [41, 79], the pulse with the maximum amplitude in the y2(n) is found. Supposing p0 is the sample corresponding to the pulse with the maximum amplitude (41≦p0≦79), the following inequality applies:

$$abs ( y 2 ( p 0 ) ) \geq abs ( y 2 ( n ) ) . n ∈ [ P MAX , \frac{L}{2} - 1 ] , n \neq p 0 \qquad ( 8 )$$

In this embodiment, the amplitude of y2(n) may be a real number, and the amplitude value of y2(n) is the absolute value of y2(n), and is a non-negative number.

Step 203: Set a target window according to the position of the pulse p0 with the maximum amplitude in the input speech signals.

Specifically, a target window is added around the pulse p0 to select parts of the signals, and this target window covers the pulse p0. The range of the target window is [s min, s max], and the target window length is len=s max−s min. The range of “len” is [1,L]. That is, the target window may cover all the signals of the frame.

For example, s min=s_max(p0−d,41),s max=s_min(p0+d,79), where d is used to limit the length of the target window. In this embodiment, d=15. s_max(p0−d,41) refers to obtaining the greater value between p0−d and 41. s_min(p0+d,79) refers to obtaining the smaller value between p0+d and 79.

Step 204: Calculate the residual signal of the input speech signal (namely, a down-sampled signal in this embodiment) corresponding to each pitch in the preset pitch range, and the residual signal is a result of removing an LTP contribution signal from the input speech signal, where the LTP contribution signal xₖ (i) is determined according to the LTP excitation signal and the pitch gain:

$${x}_{k} ( i ) = \{ \begin{matrix}y 2 ( i ) , i = 0 , 1 , … , s min - 1 \\ y 2 ( i ) - g \cdot y 2 ( i - k ) , i = s min , … , \frac{L}{2} - 1\end{matrix} \qquad ( 9 )$$

where k represents a pitch, and g represents the pitch gain. g may be a fixed empirical value, or may be a value determined adaptively according to the pitch in the preset pitch range. That is, different pitches (k) may have the same g. Alternatively, a table of mapping between the pitch k and the pitch gain g may be preset, where g varies with k.

Step 205: Calculate the energy of the residual signal corresponding to each pitch.

$$E ( k ) = {\sum }_{i = s m i n}^{s max} {x}_{k} ( i ) \cdot {x}_{k} ( i ) , k ∈ [ {k}_{1} , {k}_{2} ] \qquad ( 10 )$$

where [k₁,k₂] represents the pitch range. In one embodiment, k₁=10, k₂=41; and Eₖ(i) represents the energy of the residual signal corresponding to k.

Step 206: Select the minimum value E(P) among the calculated residual signal energy values, and E(P) is the minimum residual signal energy of the down-sampled signal y2(n) corresponding to the pitch P within the range [k₁,k₂].

Step 207: Obtain the pitch for y(n), and this pitch is 2P because y2(n) is obtained from y(n) through down-sampling by 2.

Further, to avoid mistaking the double pitch for the pitch, the method according to this embodiment may further include the following process after obtaining the pitch 2P.

In the speech signal domain, the correlation function corresponding to the obtained pitch is calculated, and the correlation function of the double pitch is calculated. This step calculates the correlation function of 2P nor_cor[2P] and the correlation function of 2P, namely, nor_cor[P], according to the following equation:

$$nor\_cor [ p ] = \frac{{\sum }_{i = p}^{L - 1} y ( i ) * y ( i - p )}{{\sum }_{i = p}^{L - 1} y ( i - p ) * y ( i - p )} , p = P , 2 P . \qquad ( 11 )$$

The pitch corresponding to the calculated maximum value of the correlation function is regarded as the final pitch. That is, the value of nor_cor[2P] is compared with the value of nor_cor[P]. If nor_cor[2P]>nor_cor[P], 2P is used as the final pitch of the speech signal. If nor_cor[2P]≦nor_cor[P], P is used as the final pitch of the speech signal.

This embodiment sets a target window and calculates the energy of the residual signals in a frame, without calculating the correlation function values of the signals in the entire frame, thus simplifying the pitch search greatly; moreover, this embodiment compares the correlation function of the pitch with the correlation function of the double pitch to avoid mistaking the double pitch for the pitch and ensure the accuracy of pitch search.

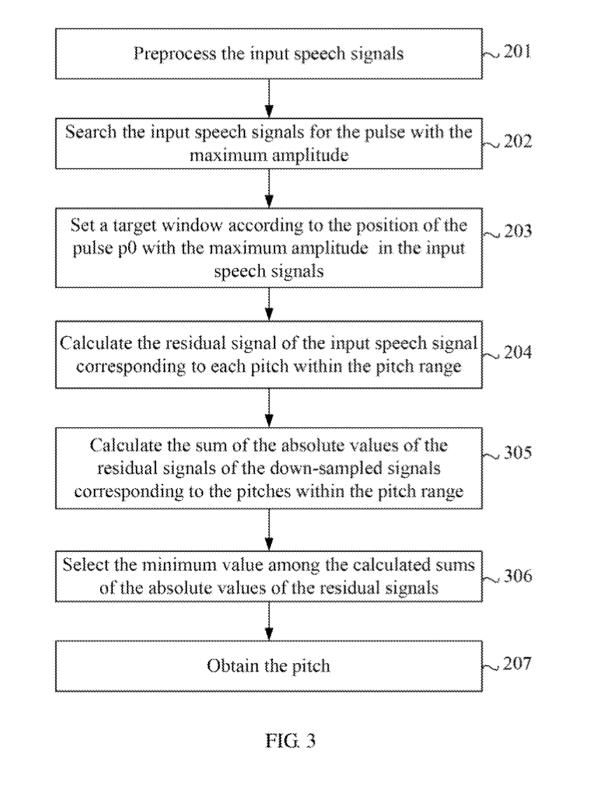

FIG. 3 is a flowchart of a method for pitch search according to yet another embodiment of the present invention. This embodiment differs from the second embodiment in that: step 205 and step 206 are replaced with step 305 and step 306, and the characteristic function value of the residual signal in this embodiment is the sum of the absolute values of the residual signals, as detailed below:

Step 305: Calculate the sum of the absolute values of the residual signals of the down-sampled signals corresponding to the pitches within the pitch range:

$$E ( k ) = {\sum }_{i = smin}^{smax} abs ( {x}_{k} ( i ) ) , k ∈ [ {k}_{1} , {k}_{2} ] \qquad ( 12 )$$

where E(k) is the sum of the absolute values of the residual signals corresponding to k.

Step 306: In the calculated sums of absolute values of residual signals, select the minimum sum E(P), which is the minimum sum of absolute values of residual signals of down-sampled signals corresponding to pitch P within the range [k₁,k₂].

This embodiment sets a target window to calculate the sum of absolute values of residual signals of the signals in a frame, without calculating the correlation function values of the signals in the entire frame, thus simplifying the pitch search greatly.

The second embodiment and the third embodiment are applicable to the scenario where the previous part of the signals in a frame is used to predict the last part of the signals in the frame. The present invention is not limited to this scenario, and is also applicable to the scenario where the signals of a previous frame are used to predict the signals of the current frame. In this scenario, the characteristic function values of the residual signals of the entire frame may be obtained first, and then the pitch is obtained according to the characteristic function values of the residual signals of the entire frame.

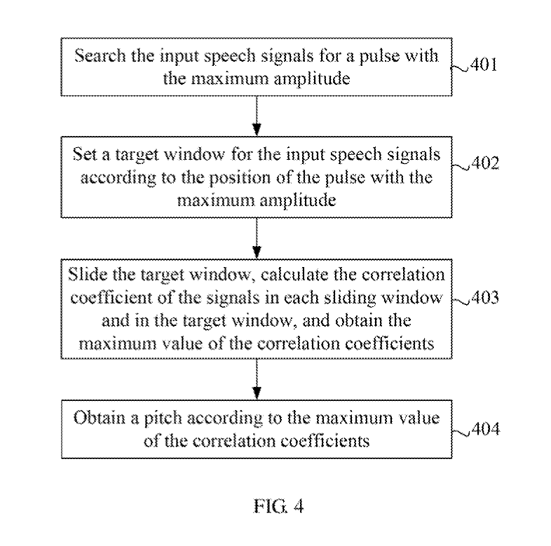

FIG. 4 is a flowchart of method for pitch search according to yet another embodiment of the present invention. The method includes the following steps:

Step 401: Search the input speech signals for a pulse with the maximum amplitude.

Step 402: Set a target window for the input speech signals according to the position of the pulse with the maximum amplitude.

Step 403: Slide the target window to obtain a plurality of sliding windows, calculate the correlation coefficient of the input speech signals in each sliding window and in the target window, and obtain the maximum value of the correlation coefficients.

Step 404: Obtain a pitch according to the maximum value of the correlation coefficients.

This embodiment sets a target window, slides the target window, and calculates the correlation coefficient of the signals in each sliding window and in the target window to obtain the maximum value of the correlation coefficients, and obtains a pitch according to the maximum value of the correlation coefficients, without calculating the correlation function values of the input speech signals in the entire frame, thus simplifying the pitch search greatly.

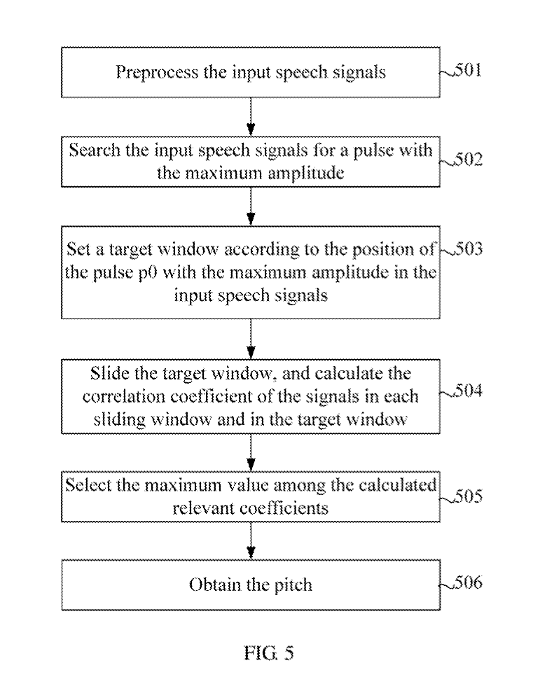

FIG. 5 is a flowchart of method for pitch search according to yet another embodiment of the present invention. The method includes the following steps:

Step 501: Preprocess the input speech signals.

Further, the preprocessing may be low-pass filtering or down-sampling, or may be a low-pass filtering process followed by a down-sampling process. Specifically, the low-pass filtering may be mean-value filtering. Taking a PCM signal as an example, y(n) represents an input speech signal, and the frame length L of the input speech signal is 160 (that is, one frame includes 160 samples); y2(n) represents the down-sampled input speech signal, and is hereinafter referred to as a down-sampled signal. Taking the down-sampling by 2 as an example in one embodiment, the following equation applies:

$$y 2 ( n ) = \frac{1}{M} {\sum }_{i = 1}^{M} y ( 2 n - i ) , n = 0 , 1 , … , ( L / 2 - 1 ) . \qquad ( 13 )$$

where, M is the order of the mean filter, and the sample range of y2(n) is [0, 79].

This step is optional. The preprocessing may be omitted before step 502 occurs.

Step 502: Search the input speech signals for a pulse with the maximum amplitude.

The pulse may be searched out within the entire frame, or within a set range of a frame. Supposing the pulse is searched out in a set range of a frame, the process is detailed below:

First, for the input speech signal y(n), its pitch range is pre-set according to the frame length. The pitch range is set with reference to the frame length, and the pitch should not be too high. If the pitch is too high, few samples in the signals of a frame are involved in the LTP calculation, and the LTP performance is degraded. For example, if the frame length L equals to 160, the pitch range of y(n) may set to [20, 83]. According to one embodiment, down-sampling by 2 is applied in step 202. The pitch range of the down-sampled signal y2(n) may be [10, 41], namely, [PMIN, PMAX], where PMIN=10, and PMAX=41. To ensure the pitch to be findable when the pitch is the maximum, the sample range of the pulse being searched may set to [41, 79].

Afterward, within the sample range [41, 79], the pulse with the maximum amplitude in the y2(n) is found. Supposing p0 is the sample corresponding to the pulse with the maximum amplitude (41≦p0≦79), the following inequality applies:

$$abs ( y 2 ( p 0 ) ) \geq abs ( y 2 ( n ) ) , n ∈ [ P MAX , \frac{L}{2} - 1 ] , n \neq p 0 \qquad ( 14 )$$

In this embodiment, the amplitude of y2(n) may be a real number, and the amplitude value of y2(n) is the absolute value of y2(n), and is a non-negative number.

Step 503: Set a target window for the input speech signals according to the position of the pulse p0 with the maximum amplitude in the input speech signals.

Specifically, a target window is added around the pulse p0 to select parts of the signals, and this target window covers the pulse p0. The range of the target window is [s min, s max], and the target window length is len=s max−s min. The range of “len” is [1,L]. That is, the target window may cover all the signals of the frame.

For example, s min=s_max(p0−d,41),s max=s_min(p0+d,79), where d is used to limit the length of the target window. In one embodiment, d=15. s_max(p0−d,41) refers to obtaining the greater value between p0−d and 41. s_min(p0+d,79) refers to obtaining the smaller value between p0+d and 79.

Step 504: Slide the target window to obtain a plurality of sliding windows, and calculate the correlation coefficient of the signals in each sliding window and in the target window.

$$corr [ k ] = {\sum }_{i = smin}^{smax - 1} y 2 ( i ) * y 2 ( i - k ) , k ∈ [ {k}_{1} , {k}_{2} ] \qquad ( 15 )$$

where k represents the pitch, and [k₁,k₂] represents the pitch range. In one embodiment, k₁=10; k₂=41; and corr[k] represents the correlation coefficient corresponding to k.

Step 505: Select the maximum correlation coefficient corr[P] among the calculated correlation coefficients, and corr[P] is the maximum correlation coefficient of the down-sampled signal corresponding to the pitch P within the range [k₁,k₂].

Step 506: Obtain the pitch for y(n), and this pitch is 2P because y2(n) is obtained from y(n) through down-sampling by 2.

Further, to avoid mistaking the double pitch for the pitch, the method according to this embodiment may further include the following process after obtaining the pitch 2P:

In the speech signal domain, the correlation function of the obtained pitch is calculated, and the correlation function of the double frequency of the obtained pitch is calculated. This step calculates the correlation function of 2P nor_cor[2P] and the correlation function of the double frequency (P) of 2P, namely, nor_cor[P], according to the following equation:

$$nor\_cor [ p ] = \frac{{\sum }_{i = p}^{L - 1} y ( i ) * y ( i - p )}{{\sum }_{i = p}^{L - 1} y ( i - p ) * y ( i - p )} , p = P , 2 P . \qquad ( 16 )$$

The pitch corresponding to the calculated maximum value of the correlation function is used as the final pitch. That is, the value of nor_cor[2P] is compared with the value of nor_cor[P]. If nor_cor[2P]>nor_cor[P], 2P is used as the final pitch of the speech signal. If nor_cor[2P]≦nor_cor[P], P is used as the final pitch of the speech signal.

This embodiment sets a target window and slides the target window, calculates the correlation coefficient of the signals in each sliding window and in the target window; and obtains a pitch according to the maximum value of the correlation coefficients, without calculating the correlation function values of the signals in the entire frame, thus simplifying the pitch search greatly; moreover, this embodiment compares the correlation function of the pitch with the correlation function of the double pitch to avoid mistaking the double pitch for the pitch and ensure accuracy of pitch search.

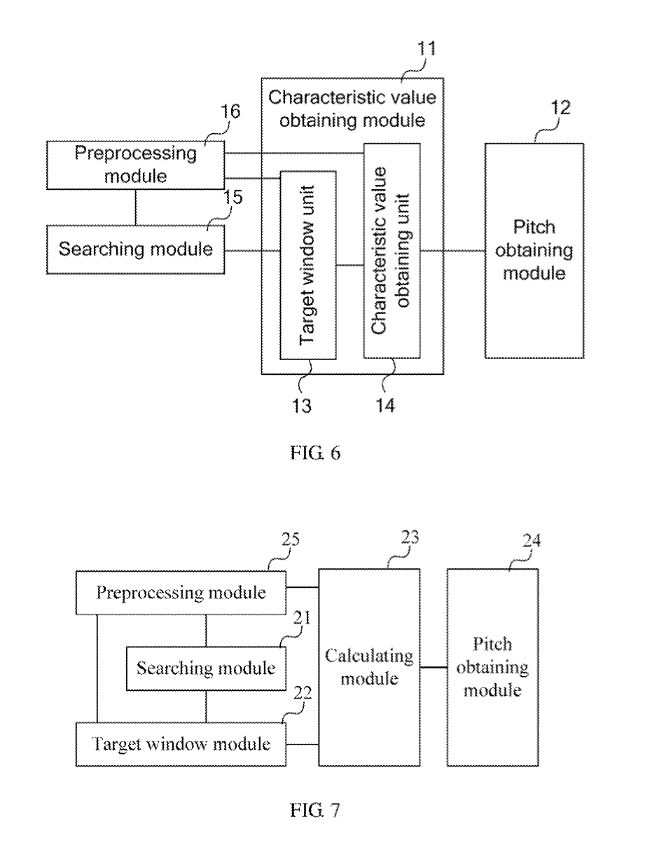

FIG. 6 shows a schematic structural view of an apparatus for pitch search according to one embodiment of the present invention. The apparatus includes: a characteristic value obtaining module 11, adapted to obtain a characteristic function value of a residual signal, where the residual signal is a result of removing an LTP contribution signal from input speech signals; and a pitch obtaining module 12, adapted to obtain a pitch according to the characteristic function value of the residual signal.

Specifically, the characteristic value obtaining module 11 may calculate the characteristic function values of the residual signals of the entire frame. The characteristic value obtaining module 11 may include a target window unit 13 and a characteristic value obtaining unit 14. The target window unit 13 sets a target window for the input speech signals, and the characteristic value obtaining unit 14 obtains the characteristic values of the residual signals in the target window.

Further, the apparatus according to this embodiment may include a searching module 15. The searching module 15 searches the input speech signals for a pulse with the maximum amplitude. The target window unit 13 sets a target window according to the position of the pulse with the maximum amplitude in the input speech signals.

The apparatus according to this embodiment may further include a preprocessing module 16. The preprocessing module 16 preprocesses the input speech signals. Specifically, the preprocessing module 16 performs low-pass filtering or down-sampling processing, and transmits the preprocessed input speech signals to the target window unit 13 and the characteristic value obtaining unit 14.

The characteristic value obtaining module 11 may further include a first calculating unit and a second calculating unit. The first calculating unit calculates the residual signal corresponding to each pitch within the preset pitch range. The second calculating unit calculates the characteristic function value of the residual signal corresponding to each pitch, and obtains the minimum value of the characteristic function value. The pitch obtaining module 12 uses the pitch corresponding to the minimum value of the characteristic function value as the obtained pitch.

This embodiment sets a target window to calculate the characteristic function values of the residual signals of the signals in a frame, without calculating the correlation function values of the signals in the entire frame, thus simplifying the pitch search greatly.

FIG. 7 shows a structure view of apparatus for pitch search according to another embodiment of the present invention. The apparatus includes: a searching module 21, a target window module 22, a calculating module 23, and a pitch obtaining module 24. The searching module 21 searches the input speech signals for a pulse with the maximum amplitude. The target window module 22 sets a target window for the input speech signals according to the position of the pulse with the maximum amplitude. When the target window is sliding, the calculating module 23 calculates the correlation coefficient of the input speech signals in each sliding window and in the target window to obtain the maximum value of the correlation coefficients. The pitch obtaining module 24 obtains a pitch according to the maximum value of the correlation coefficients.

The apparatus according to one embodiment may further include a preprocessing module 25. The preprocessing module 25 preprocesses the input speech signals. Specifically, the preprocessing module 25 performs low-pass filtering or down-sampling processing, and transmits the preprocessed input speech signals to the searching module 21, target window module 22, and calculating module 23.

This embodiment sets a target window, slides the target window, and calculates the correlation coefficient of the signals in each sliding window and in the target window to obtain the maximum value of the correlation coefficients, and obtains a pitch according to the maximum value of the correlation coefficients, without calculating the correlation function values of the input speech signals in the entire frame, thus simplifying the pitch search greatly.

It is understandable to those skilled in the art that all or part of the steps of the foregoing method embodiments may be implemented by hardware instructed by a program. The program may be stored in a computer-readable storage medium. When being executed, the program performs steps of the foregoing method embodiments. The storage medium may be any medium suitable for storing program codes, for example, a Read Only Memory (ROM), a Random Access Memory (RAM), a magnetic disk, or a compact disk.

Although the invention is described through several exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

1. A method for pitch search, comprising:
obtaining a characteristic function value of a residual signal, where the residual signal is a result of removing an LTP contribution signal from input speech signals; and
obtaining a pitch according to the characteristic function value of the residual signal.

2. The method according to claim 1, wherein the process of obtaining a characteristic function value of a residual signal comprises:
setting a target window for the input speech signals, and obtaining the characteristic function value of the residual signals among the target window.

3. The method according to claim 1, wherein the process of setting a target window for the input speech signals comprises:
searching the input speech signals for a pulse with the maximum amplitude; and
setting the target window according to the position of the pulse.

4. The method according to claim 3, wherein
the process of obtaining a characteristic function value of a residual signal comprises:
calculating the residual signal corresponding to each pitch in the preset pitch range; and
calculating the characteristic function value of the residual signal corresponding to each pitch;
the process of obtaining a pitch according to the characteristic function value of the residual signal comprises:
selecting a minimum value among the calculated residual signal energy values, and setting the pitch corresponding to the minimum value as the pitch.

5. The method according to claim 4, wherein,
the characteristic function value of the residual signal is the residual signal energy value.

6. The method according to claim 4, wherein,
the characteristic function value of the residual signal is the sum of the absolute values of the residual signals.

7. The method according to claim 1, wherein
the process of obtaining a characteristic function value of a residual signal comprises:
calculating the residual signal corresponding to each pitch in the preset pitch range; and
calculating the characteristic function value of the residual signal corresponding to each pitch;
the process of obtaining a pitch according to the characteristic function value of the residual signal comprises:
selecting a minimum value among the calculated residual signal energy values, and setting the pitch corresponding to the minimum value as the pitch.

8. The method according to claim 1, wherein, before the process of obtaining a characteristic function value of a residual signal, the method further comprises:
low-pass filtering or down-sampling the input speech signals.

9. The method according to claim 1, wherein LTP contribution signal is determined based on an LTP excitation signal and a pitch gain, and the pitch gain is a fixed value or a value determined adaptively according to the pitch in the preset pitch range.

10. A method for pitch search, comprising:
searching the input speech signals for a pulse with the maximum amplitude;
setting a target window for the input speech signals according to the position of the pulse;
sliding the target window to obtain a plurality of sliding windows, calculating the correlation coefficient of the input speech signals in each sliding window and in the target window to obtain the maximum value of the correlation coefficients; and
obtaining a pitch according to the maximum value of the correlation coefficients.

11. The method according to claim 10, wherein before the process of searching the input speech signals for a pulse with the maximum amplitude, the method further comprises:
low-pass filtering or down-sampling the input speech signals.

12. An apparatus for pitch search, comprising:
a characteristic value obtaining module, adapted to obtain a characteristic function value of a residual signal, where the residual signal is a result of removing an LTP contribution signal from input speech signals; and
a pitch obtaining module, adapted to obtain a pitch according to the characteristic function value of the residual signal.

13. The apparatus according to claim 12, wherein
the characteristic value obtaining module is adapted to calculate the characteristic function values of the residual signals of the entire frame; or
the characteristic value obtaining module comprises:
a target window unit, adapted to set a target window for the input speech signals and
a characteristic value obtaining unit, adapted to obtain the characteristic values of the residual signals in the target window.

14. The apparatus according to claim 13, further comprising:
a searching module, adapted to search the input speech signals for a pulse with the maximum amplitude; and
the target window unit, further adapted to sets the target window according to the position of the pulse with the maximum amplitude in the input speech signals.

15. The apparatus according to claim 14, wherein the characteristic value obtaining module comprises:
a first calculating unit, adapted to calculate the residual signal corresponding to each pitch within the preset pitch range; and
a second calculating unit, adapted to calculate the characteristic function value of the residual signal corresponding to each pitch, and obtain the minimum value of the characteristic function value, wherein the pitch obtaining module uses the pitch corresponding to the minimum value of the characteristic function value as the obtained pitch.

16. The apparatus according to claim 12, wherein the characteristic value obtaining module comprises:
a first calculating unit, adapted to calculate the residual signal corresponding to each pitch within the preset pitch range; and
a second calculating unit, adapted to calculate the characteristic function value of the residual signal corresponding to each pitch, and obtain the minimum value of the characteristic function value, wherein the pitch obtaining module uses the pitch corresponding to the minimum value of the characteristic function value as the obtained pitch.

17. The apparatus according to claim 13, further comprising:
a preprocessing module, adapted to perform low-pass filtering or down-sampling processing on input speech signals.

18. An apparatus for pitch search, comprising:
a searching module, adapted to search the input speech signals for a pulse with the maximum amplitude;
a target window module, adapted to set a target window for the input speech signals according to the position of the pulse with the maximum amplitude;
a calculating module, adapted to slide the target window and calculate the correlation coefficient of the input speech signals in each sliding window and in the target window to obtain the maximum value of the correlation coefficients; and
a pitch obtaining module, adapted to obtain a pitch according to the maximum value of the correlation coefficients.

19. The apparatus according to claim 18, further comprising:
a preprocessing module, adapted to perform low-pass filtering or down-sampling processing on input speech signals.
